(19) United States
(12) Patent Application Publication
(10) Pub. No.: US 2015/0019334 A1
(43) Pub. Date: Jan. 15, 2015

(54) SYSTEMS AND METHODS FOR PROVIDING TARGETED MESSAGING WHEN TARGETING TERMS ARE UNAVAILABLE

(71) Applicant: Infolinks, Inc., Palo Alto, CA (US)

(72) Inventors: Moshe Moses, Kfar Saba (IL); Asi Moshe, Tel Aviv (IL); Yariv Davidovich, Palo Alto, CA (US)

(21) Appl. No.: 13/938,189

(22) Filed: Jul. 9, 2013

(51) Int. Cl. G06Q 30/02

(52) U.S. Cl. CPC G06Q 30/0256
USPC 705/14.54

(57) ABSTRACT

Systems and methods for providing a targeted message based on at least one targeting term are provided herein. Some embodiments may include a machine having circuitry configured to receive a request to present a targeted message. In response to receiving the request, the circuitry can be configured to determine whether one or more targeting terms are included in the request and are available. In response to determining that the targeting terms are unavailable, the circuitry may access historical information associated with available targeting terms and provide a targeted message based on the historical information.

### FIELD

Embodiments of the invention relate, generally, to providing targeted messages in a network-based environment.

### BACKGROUND

Targeted messaging, such as at a publisher's webpage, can be improved if the publisher knows the targeting terms, such as search terms that a user entered into the search engine to arrive at the webpage. As used herein, a “targeting term” refers to a group of one or more words that can be search terms, keywords, and other information used to provide targeted messages. For example, the user may enter a targeted term (e.g., search terms) to a search engine, causing the search engine to generate a link or other reference to a webpage. In this regard, areas for improving current systems have been identified.

### BRIEF SUMMARY

Through applied effort, ingenuity, and innovation, solutions to improve such systems have been realized and are described herein. In general, techniques are provided to improve targeting term based advertising. Systems and methods for providing a targeted message based on at least one targeting term are provided herein. Embodiments discussed herein may include a machine having circuitry configured to receive a request to present a targeted message. In response to receiving the request, the circuitry can be configured to determine whether one or more targeting terms are included in the request and are available. In response to determining that the targeting terms are unavailable, the circuitry may access historical information associated with available targeting terms and provide a targeted message based on the historical information. In some embodiments, the targeting terms may be search terms and the search terms may be unavailable because the search terms were omitted by a search engine.

In some embodiments, the circuitry may be further configured to: receive a second request to present a second targeted message; in response to receiving the second request, determine whether at least one second targeting term is included in the second request and is available. In response to determining the second targeting term is included in the second targeted message and available, the circuitry may be further configured to: extract the second targeting term; compare the second targeting term with keywords associated with targeted messages; in response to determining the second targeting term matches one of the keywords, provide a keyword-based targeted message associated with the one of the keywords; and store the second targeting term in a database such that the second targeting term is associated with the historical information.

In some embodiments, the circuitry may be further configured to, in response to determining the second targeting term is included in the second targeted message and available: receive user information associated with a user indicating an advertising territory of the user; and store the user information in the database such that the user information is associated with the historical information.

In some embodiments, the circuitry may be further configured to access the historical information by: generating a ranking request to a database, the ranking request indicating one or more ranking criteria for targeting terms; and receiving the historical information from the database, the historical information indicating a ranking of one or more targeting terms based on the one or more ranking criteria. For example, the ranking may be based on country code and targeting term count. In another example, the ranking may be based on one or more of publisher webpage referral count, dwell time, price for historic targeted advertisement bids, targeted advertisement click rate, time of collection for the targeting terms, and search engine source. The circuitry may be further configured to: determine an estimated targeting term based on the ranking; and provide the targeted message based on the estimated targeting term.

In some embodiments, the circuitry may be further configured to: determine an extracted targeting term from a publisher webpage; and associate the extracted targeting term the historical information.

In some embodiments, the circuitry may be further configured to: receive user information associated with a user indicating an advertising territory of the user; determine an estimated targeting term based on the user information; and provide the targeted message based on the user information.

In some embodiments, the processing circuitry may be further configured to: determine an estimated targeting term based on the historical information; send the estimated targeting term to one or more targeted message provider servers; receive one or more targeted message bids each including an associated price from the one or more targeted message provider servers; and determine the targeted message from the one or more targeted message bids based on the associated prices. The circuitry may be further configured to: receive user information associated with the user indicating a demographic of the user; and send the user information to the one or more targeted message provider servers for determination of the one or more advertisement bids.

In some embodiments, the circuitry may be further configured to: receive the historical information as browser cookie data from a user device associated with a user; and provide the targeted message to the user device.

Some embodiments may provide for a method for providing an advertisement. The method may include: receiving a request to present a targeted message; in response to receiving the request, determining whether one or more targeting terms are included in the request and are available; in response to determining that the targeting terms are unavailable, accessing historical information associated with available targeting terms; and providing a targeted message based on the historical information. For example, the targeting terms may be search terms and the search terms may be unavailable because the search terms were omitted by a search engine.

In some embodiments, the method may further include: receiving a second request to present a second targeted message; in response to receiving the second request, determining whether at least one second targeting term is included in the second request and is available. In response to determining the second targeting term is included in the second targeted message and available, the method may further include: extracting the second targeting term; comparing the second targeting term with keywords associated with targeted messages; in response to determining the second targeting term matches one of the keywords, providing a keyword-based targeted message associated with the one of the keywords; and storing the second targeting term in a database such that the second targeting term is associated with the historical information.

In some embodiments, the method may further include, in response to determining the second targeting term is included in the second targeted message and available: receiving user information associated with a user indicating an advertising territory of the user; and storing the user information in the database such that the user information is associated with the historical information. For example, accessing the historical information may include: generating a ranking request to a database, the ranking request indicating one or more ranking criteria for targeting terms; and receiving the historical information from the database, the historical information indicating a ranking of one or more targeted terms based on the one or more ranking criteria.

In some embodiments, the ranking may be based on country code and targeting term count. The ranking may be additionally and/or alternatively based on one or more of publisher webpage referral count, dwell time, price for historic advertisement bids, advertisement click rate, time of collection for the targeting terms, and search engine source. The method may further include: determining an estimated targeting term based on the ranking; and providing the targeted message based on the estimated targeting term.

In some embodiments, the method may further include: determining an extracted targeting term from a publisher webpage; and associating the extracted targeting term the historical information.

In some embodiments, the method may further include: receiving user information associated with a user indicating an advertising territory of the user; determining an estimated targeting term based on the user information; and providing the targeted message based on the user information.

In some embodiments, the method may further include: determining an estimated targeting term based on the historical information; sending the estimated targeting term to one or more targeted message provider servers; receiving one or more targeted message bids each including an associated price from the one or more targeted message provider servers; and determining the targeted message from the one or more targeted message bids based on the associated prices.

In some embodiments, the method may further include: receiving user information associated with the user indicating a demographic of the user; and sending the user information to the one or more targeted message provider servers for determination of the one or more advertisement bids.

In some embodiments, the method may further include: receiving the historical information as browser cookie data from a user device associated with a user; and providing the targeted message to the user device.

Some embodiments may include circuitry and/or non-transitory computer readable storage media configured to implement the methods and/or other functionality discussed herein. For example, one or more processors, and/or other machine components may be configured to implement the functionality discussed herein based on instructions and/or other data stored in memory and/or other non-transitory computer readable media.

These characteristics as well as additional features, functions, and details of various embodiments are described below. Similarly, corresponding and additional embodiments are also described below.

### BRIEF DESCRIPTION OF THE DRAWINGS

Having thus described some embodiments in general terms, reference will now be made to the accompanying drawings, which are not necessarily drawn to scale, and wherein:

FIG. 1 shows an example system in accordance with some embodiments;

FIG. 2 shows example circuitry in accordance with some embodiments;

FIG. 3 shows an example of a method for providing a targeted message, performed in accordance with some embodiments;

FIG. 4 shows an example search engine main display in accordance with some embodiments;

FIG. 5 shows an example search engine results display in accordance with some embodiments;

FIG. 6 shows an example targeted message display in accordance with some embodiments;

FIG. 7 shows an example of a method for generating live targeting term data performed in accordance with some embodiments;

FIG. 8 shows an example table including live targeted term data;

FIG. 9 shows an example of a method for determining an estimated targeted term, performed in accordance with some embodiments;

FIG. 10 shows an example of a method for generating a targeted message based on the estimated targeted term, performed in accordance with some embodiments; and

FIG. 11 shows an example targeted message display in accordance with some embodiments.

### DETAILED DESCRIPTION

Embodiments will be described more fully hereinafter with reference to the accompanying drawings, in which some, but not all embodiments contemplated herein are shown. Indeed, various embodiments may be implemented in many different forms and should not be construed as limited to the embodiments set forth herein; rather, these embodiments are provided so that this disclosure will satisfy applicable legal requirements. Like numbers refer to like elements throughout.

As used herein, the terms “data,” “content,” “information” and similar terms may be used interchangeably to refer to data capable of being captured, transmitted, received, displayed and/or stored in non-transitory computer readable storage media in accordance with various example embodiments. Thus, use of any such terms should not be taken to limit the spirit and scope of the disclosure. Further, where a device is described herein to receive data from another device, it will be appreciated that the data may be received directly from the another device or may be received indirectly via one or more intermediary devices, such as, for example, one or more servers, relays, routers, network access points, base stations, and/or the like, sometimes referred to herein as a “network.” Similarly, where a device is described herein to send data to another device, it will be appreciated that the data may be sent directly to the another device or may be sent indirectly via one or more intermediary devices, such as, for example, one or more servers, relays, routers, network access points, base stations, and/or the like.

As used herein, the term “method” refers to one or more steps that may be performed by a device, apparatus, system, circuitry, one or more processors, or the like. Where an example method is shown as including more than one step, it will be appreciated that the steps may be performed in different orders than as shown in the example and that not all steps are necessarily required.

### BRIEF OVERVIEW

Methods, systems, apparatus and computer program products described herein are operable to improve the providing of targeted messaging based on predefined targeting terms when the targeting terms are omitted, obfuscated and/or otherwise unavailable. For example, keywords are an example of targeting terms that can be associated with a targeted message, such as an online advertisement. Targeted terms provided by a user (e.g., to a search engine) may indicate a user's intent, such as intent to find a relevant product or service. As such, targeted terms may have a particular importance to advertisers and search engines that also function as search-related advertisement providers. Depending on variety of different factors, when a search engine directs the user to a publisher webpage (e.g., via a reference or hyperlink generated in response to the targeted terms), it may be configured to hide, omit, obfuscate, conceal, or otherwise make unavailable the targeted terms from the publisher webpage. When the targeted terms are made unavailable the targeting effectiveness of the publisher webpage's display advertising (e.g., banners, graphics, references, hyperlinks, etc.) may be reduced without the ability to leverage the knowledge attached to the targeted terms that brought the particular viewer to the webpage. As such, some embodiments discussed herein include techniques for providing display advertising and/or other messaging at a publisher's webpage or elsewhere (e.g., in a user's email inbox) having the relevance of search advertising, even when the targeted terms are concealed by a search engine and/or other potential targeting term provider.

### Exemplary System Architecture

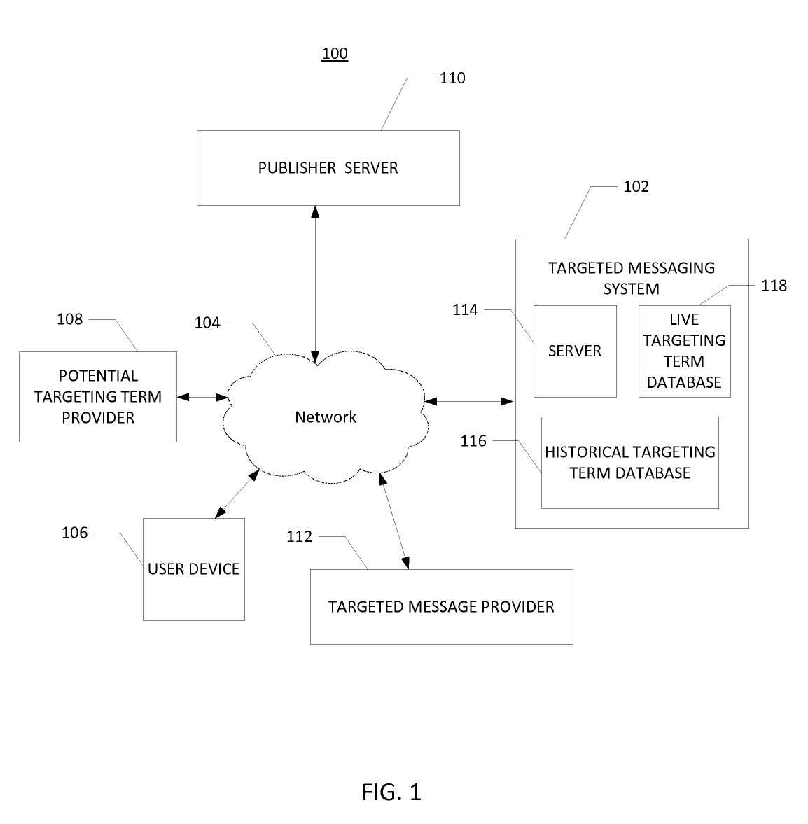

FIG. 1 shows an example system 100, in accordance with some embodiments. System 100 may include targeted messaging system 102 (or “system 102”), network 104, user device 106, potential targeting term provider 108, publisher server 110 and targeted message provider 112. System 102, user device 106, potential targeting term provider 108, publisher server 110 and/or targeted message provider 112 may be communicably connected via network 104. Furthermore, while a single user device 106, potential targeting term provider 108, publisher server 110 and targeted message provider 112 is shown to avoid overcomplicating the disclosure, system 102 may be configured to operate with one or more user devices 106, potential targeting term providers 108, publisher servers 110 and/or targeted message providers 112 in various embodiments.

In some embodiments, potential targeting term provider 108 may be a provider of search engine services and/or search advertisements. For example, via user device 106, a user may be able to provide a targeting term to potential targeting term provider 108. Potential targeting term provider 108 may then be configured to provide references, hyperlinks, or the like relevant to the targeted term. For example, potential targeting term provider 108 may provide a reference to publisher server 110. Publisher server 110 may be configured to provide content for a webpage. In some embodiments, publisher server 110 may send webpage data to user device 106 upon the user selecting the publisher's link in a results page provided by the search engine. Potential targeting term provider 108 may be configured to provide the targeted term which led to the publisher's reference being provided and/or selected in the results page. For example, if not concealed by potential targeting term provider 108, the targeted term may be extracted out of the hypertext transfer protocol (HTTP) referrer header uniform resource locator (URL) address, such as by system 102 and/or publisher server 110. In other embodiments, potential targeting term provider 108 may be an email provider, a document provider, or other online service provider.

System 102 may include server 114, historical targeting term database 116 and live targeting tern database 118. Server 114 may include circuitry, networked processors, or the like configured to perform some or all of the server-based processes described herein and may be any suitable network server and/or other type of processing device. For example, server 114 may be configured to generate “targeting term data,” which as used herein, refers to data associated with targeting terms that may be used to determine an estimated targeting term. Additionally and/or alternatively, server 114 may be configured to provide a targeted message (e.g., an advertisement) based on targeting terms, such as based on the estimated targeting term determined from the targeting term data (e.g., when no targeting term is provided by potential targeting term provider 108) and/or based on actual targeting terms provided by potential targeting term provider.

In some embodiments, system 102 may function as a “cloud” with respect to the user device 106, publisher server 110 and/or targeted message provider 112. In that sense, potential targeting term provider 108 may include several servers performing interconnected and/or distributed functions. To avoid unnecessarily overcomplicating the disclosure, potential targeting term provider 108 is shown and described herein as a single server.

Historical targeting term database 116 and/or live targeting term database 118 may be any suitable network storage device configured to store some or all of the information described herein. As such, historical targeting term database 116 and/or live targeting term database 118 may include, for example, one or more database systems, backend data servers, network databases, cloud storage devices, etc. To avoid unnecessarily overcomplicating the disclosure, historical targeting term database 116 and live targeting term database 118 are shown and described herein as each being a single database.

Historical targeting term database 116 may be configured to store historical targeting term data. Server 114 may be configured to collect and send targeting historical targeting term data that associates targeting terms with webpages provided by publisher servers 110 to historical targeting term database 116. One way by which targeting term data may be collected is when it is provided by a search engine. For example, each webpage may be associated with URL address. For each URL address, server 114 may collect and store targeting terms upon user access to the webpage when provided by potential targeting term provider 108 in historical targeting term database 116. In some embodiments, the historical targeting term data may include a count of how many times each targeting term lead a user to the URL address. For each URL address, server 114 may further categorize targeting terms by advertising territory (e.g., by country, language, product availability, etc.), user demographics, and/or other filter rules as discussed here. In other examples, historical targeting term data may be generated based extracting the publisher webpage (e.g., via machine reading), manual entry of targeting terms, receiving targeting terms from publisher server 110, etc.

Live targeting term database 118 may be configured to store live targeting term data. “Live targeting term data,” as used herein, refers to targeting term data accessed by server 114 to determine the estimated targeting term. In some embodiments, the live targeting term data may be generated based on the historical targeting term data stored in historical targeting term database 116 that has been categorized, filtered and/or otherwise processed for use. Live targeting term database 118 may be accessible to server 114, such as in real-time as updates occur. In some embodiments, historical targeting term database 116 may be a Hadoop data source that stores historical targeting term data to be loaded onto live targeting term database 118, such as when various conditions are met for a particular targeting term and associated webpage. In some embodiments, live targeting term database 118 is not used. For example, server 114 may be configured to generate the live targeting term data based on accessing historical targeting term database 116.

In some embodiments, server 114 may be further configured to generate targeted term data by communicating with user device 106 and/or publisher server 110. For example, server 114 may be configured to receive user information from user device 106 and/or extracted targeted term data (e.g., from webpages, URL addresses, meta-data, etc.) from publisher server 110. As discussed below in greater detail, the user information and/or extracted targeted term data may also be used to generate live targeted term data and/or may be used to otherwise determine the estimated targeted term based on the live targeted term data.

Network 104 may include one or more wired and/or wireless communication networks including, for example, a wired or wireless local area network (LAN), personal area network (PAN), metropolitan area network (MAN), wide area network (WAN), or the like, as well as any hardware, software and/or firmware for implementing the one or more networks (such as, e.g., network routers, switches, hubs, etc.). For example, network 104 may include a cellular telephone, mobile broadband, long term evolution (LTE), GSM/EDGE, UMTS/HSPA, IEEE 802.11, IEEE 802.16, IEEE 802.20, WiFi, dial-up, and/or WiMax network. Furthermore, network 104 may include a public network, such as the Internet, a private network, such as an intranet, or combinations thereof, and may utilize a variety of networking protocols now available or later developed including, but not limited to TCP/IP based networking protocols.

User device 106 may be associated with the user. User device 106 may be configured to present content, facilitate electronic communications, perform computing functionality, and/or the like. Although a single user device 106 is shown, search system 100 may include any number of user devices that may be associated with various other users. User device 106 may be a mobile device and/or a stationary device. For example, user device 106 may be a mobile device such as a cellular telephone (including smartphones and/or other types of mobile telephones), laptop, tablet, electronic reader, e-book device, media device, and/or the like. Additionally and/or alternatively, user device 106 may be a stationary device such as a desktop computer, work station, point-of-sale device, or the like.

Targeted message provider 112 may be one or more servers configured to provide advertisement data to system 102. For example, targeted message provider 112 may be associated with one or more advertisers of a product and/or service. Targeted message provider 112 may be configured to receive a targeted term and/or estimated targeted term from system 102, and in response, may be configured to send an advertisement and/or advertisement bid. In some embodiments, depending on the advertisement bids received from one or more targeted message providers 112, system 102 may be configured to provide a targeted message for display on user device 106 when the user has accessed the webpage provided by publisher server 110.

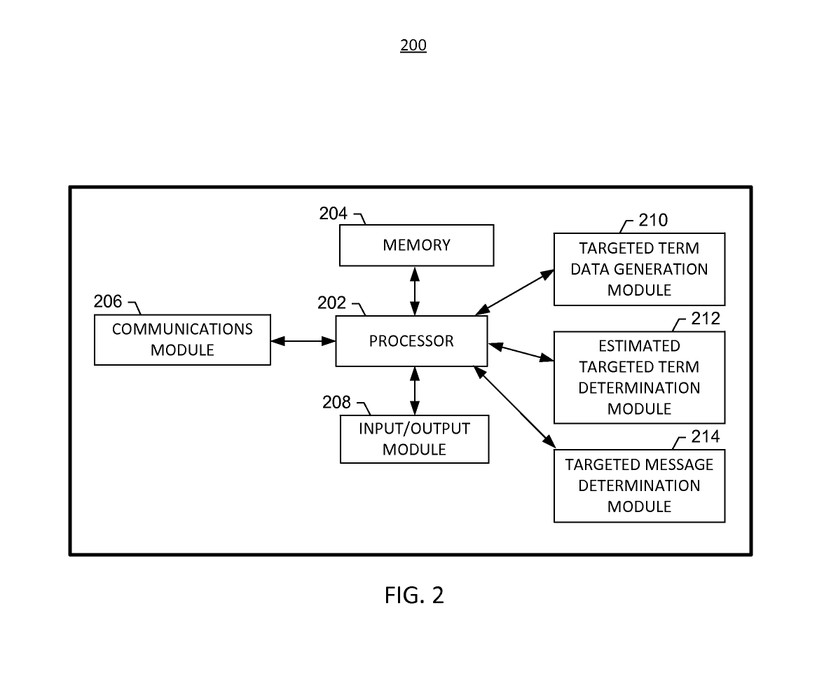

FIG. 2 shows a schematic block diagram of example circuitry 200, some or all of which may be included in system 102, user device 106, potential targeting term provider 108, publisher server 110 and/or targeted message provider 112. In accordance with some example embodiments, circuitry 200 may include various means, such as one or more processors 202, memories 204, input/output modules 208, and/or communications modules 210.

In some embodiments, such as when circuitry 200 is included in system 102 (e.g., as server 114), targeted term data generation module 210, estimated targeted term determination module 212, and/or targeted message determination module 214 may also or instead be included. As referred to herein, “module” includes hardware, software and/or firmware configured to perform one or more particular functions. In this regard, the means of circuitry 200 as described herein may be embodied as, for example, circuitry, hardware elements (e.g., a suitably programmed processor, combinational logic circuit, integrated circuit, and/or the like), a computer program product comprising computer-readable program instructions stored on a non-transitory computer-readable medium (e.g., memory 204) that is executable by a suitably configured processing device (e.g., processor 202), or some combination thereof.

Processor 202 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 2 as a single processor, in some embodiments, processor 202 may comprise a plurality of processing means. The plurality of processing means may be embodied on a single computing device or may be distributed across a plurality of computing devices collectively configured to function as circuitry 200. The plurality of processing means may be in operative communication with each other and may be collectively configured to perform one or more functionalities of circuitry 200 as described herein. In an example embodiment, processor 202 may be configured to execute instructions stored in memory 204 or otherwise accessible to processor 202. These instructions, when executed by processor 202, may cause circuitry 200 to perform one or more of the functionalities described herein.

Whether configured by hardware, firmware/software methods, or by a combination thereof, processor 202 may comprise an entity capable of performing operations according to embodiments of the present invention while configured accordingly. Thus, for example, when processor 202 is embodied as an ASIC, FPGA or the like, processor 202 may comprise specifically configured hardware for conducting one or more operations described herein. As another example, when processor 202 may be embodied as an executor of instructions, such as may be stored in memory 204, the instructions may specifically configure processor 202 to perform one or more algorithms, methods or operations described herein. For example, processor 202 may be configured to execute operating system applications, firmware applications, media playback applications, media editing applications, among other things.

Memory 204 may comprise, for example, volatile memory, non-volatile memory, or some combination thereof. Although illustrated in FIG. 2 as a single memory, memory 204 may comprise a plurality of memory components. The plurality of memory components may be embodied on a single computing component or distributed across a plurality of computing components. In various embodiments, memory 204 may comprise, for example, a hard disk, random access memory, cache memory, flash memory, a compact disc read only memory (CD-ROM), solid state memory, digital versatile disc read only memory (DVD-ROM), an optical disc, circuitry configured to store information, integrated circuitry, chemical/biological memory, paper, or some combination thereof. Memory 204 may be configured to store information, data, applications, instructions, or the like for enabling circuitry 200 to carry out various functions in accordance with example embodiments discussed herein. For example, in at least some embodiments, memory 204 may be configured to buffer input data for processing by processor 202. Additionally or alternatively, in at least some embodiments, memory 204 may be configured to store program instructions for execution by processor 202 and/or data for processing by processor 202. Memory 204 may store information in the form of static and/or dynamic information. This stored information may be stored and/or used by circuitry 200 during the course of performing its functionalities.

Communications module 206 may be embodied as any component or means embodied in circuitry, hardware, a computer program product comprising computer readable program instructions stored on a computer readable medium (e.g., memory 204) and executed by a processing device (e.g., processor 202), or a combination thereof that is configured to receive and/or transmit data from/to another device, such as, for example, a second circuitry 200 and/or the like. In some embodiments, communications module 206 (like other components discussed herein) can be at least partially embodied as or otherwise controlled by processor 202. In this regard, communications module 206 may be in communication with processor 202, such as via a bus. Communications module 206 may include, for example, an antenna, a transmitter, a receiver, a transceiver, network interface card and/or supporting hardware and/or firmware/software for enabling communications. Communications module 206 may be configured to receive and/or transmit any data that may be stored by memory 204 using any protocol that may be used for communications. Communications module 206 may additionally and/or alternatively be in communication with the memory 204, input/output module 208 and/or any other component of circuitry 200, such as via a bus.

Input/output module 208 may be in communication with processor 202 to receive an indication of an input and/or to provide an audible, visual, mechanical, or other output. In that sense, input/output module 208 may include means for performing analog-to-digital and/or digital-to-analog data conversions. Input/output module 208 may include support, for example, for a display, touch screen, keyboard, button, click wheel, mouse, joystick, an image capturing device, microphone, speaker, biometric scanner, and/or other input/output mechanisms. In embodiments where circuitry 200 may be implemented as a server or database, aspects of input/output module 208 may be reduced as compared to embodiments where circuitry 200 may be implemented as an end-user machine or other type of device designed for complex user interactions. In some embodiments (like other components discussed herein), input/output module 208 may even be eliminated from circuitry 200. Alternatively, such as in embodiments wherein circuitry 200 is embodied as a server or database, at least some aspects of input/output module 208 may be embodied on an apparatus used by a user that is in communication with circuitry 200. Input/output module 208 may be in communication with memory 204, communications module 206, and/or any other component(s), such as via a bus. Although more than one input/output module and/or other component can be included in circuitry 200, only one is shown in FIG. 2 to avoid overcomplicating the disclosure (e.g., like the other components discussed herein).

In some embodiments, targeted term data generation module 210, estimated targeted term determination module 212, and/or targeted message determination module 214 module 210 may also or instead be included and configured to perform the functionality discussed herein related to generating targeted term data, determining the estimated targeted term, and providing the targeted message based on the estimated targeted term, respectively. In some embodiments, some or all of the functionality of targeted term data generation module 210, estimated targeted term determination module 212, and/or targeted advertisement determination module 214 may be performed by processor 202. In this regard, the example processes and algorithms discussed herein can be performed by at least one processor 202 and/or modules 210-214. For example, non-transitory computer readable storage media can be configured to store firmware, one or more application programs, and/or other software, which include instructions and other computer-readable program code portions that can be executed to control processors of the components of system 200 to implement various operations, including the examples shown above. As such, a series of computer-readable program code portions may be embodied in one or more computer program products and can be used, with a device, server, database, and/or other programmable apparatus, to produce the machine-implemented processes discussed herein.

Any such computer program instructions and/or other type of code may be loaded onto a computer, processor or other programmable apparatus's circuitry to produce a machine, such that the computer, processor other programmable circuitry that executes the code may be the means for implementing various functions, including those described herein. In some embodiments, one or more external systems (such as a remote cloud computing and/or data storage system) may also be leveraged to provide at least some of the functionality discussed herein.

As described above and as will be appreciated based on this disclosure, various embodiments may be implemented as methods, mediums, devices, servers, databases, systems, and the like. Accordingly, embodiments may comprise various means including entirely of hardware or any combination of software and hardware. Furthermore, embodiments may take the form of a computer program product on at least one non-transitory computer-readable storage medium having computer-readable program instructions (e.g., computer software) embodied in the storage medium. Any suitable computer-readable storage medium may be utilized including non-transitory hard disks, CD/DVD-ROMs, flash memory, optical storage devices, quantum storage devices, chemical storage devices, biological storage devices, magnetic storage devices, etc.

Embodiments have been described above with reference to block diagrams of components, such as functional modules, system components and circuitry. Below is a discussion of an example process flowcharts describing functionality that may be implemented by one or more components discussed above. Each block of the block diagrams and process flowcharts, and combinations of blocks diagrams and process flowcharts, respectively, can be implemented by various means including computer program instructions. These computer program instructions may be loaded onto a general purpose computer, special purpose computer, or other programmable data processing apparatus, such as processor 202, to produce a machine, such that the computer program product includes the instructions which execute on the computer or other programmable data processing apparatus to create a means for implementing the functions specified in the flowchart block or block diagrams.

These computer program instructions may also be stored in a computer-readable storage device (e.g., memory 204) that can direct a computer or other programmable data processing apparatus to function in a particular manner, such that the instructions stored in the computer-readable storage device produce an article of manufacture including computer-readable instructions for implementing the function discussed herein. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions discussed herein.

Accordingly, blocks of the block diagrams and flowchart illustrations support combinations of means for performing the specified functions, combinations of steps for performing the specified functions and program instruction means for performing the specified functions. It will also be understood that each block of the block diagrams and process flowcharts, and combinations of blocks in the block diagrams and process flowcharts, can be implemented by special purpose hardware-based computer systems that perform the specified functions or steps, or combinations of special purpose hardware and computer instructions.

### Advertisement Search Overview

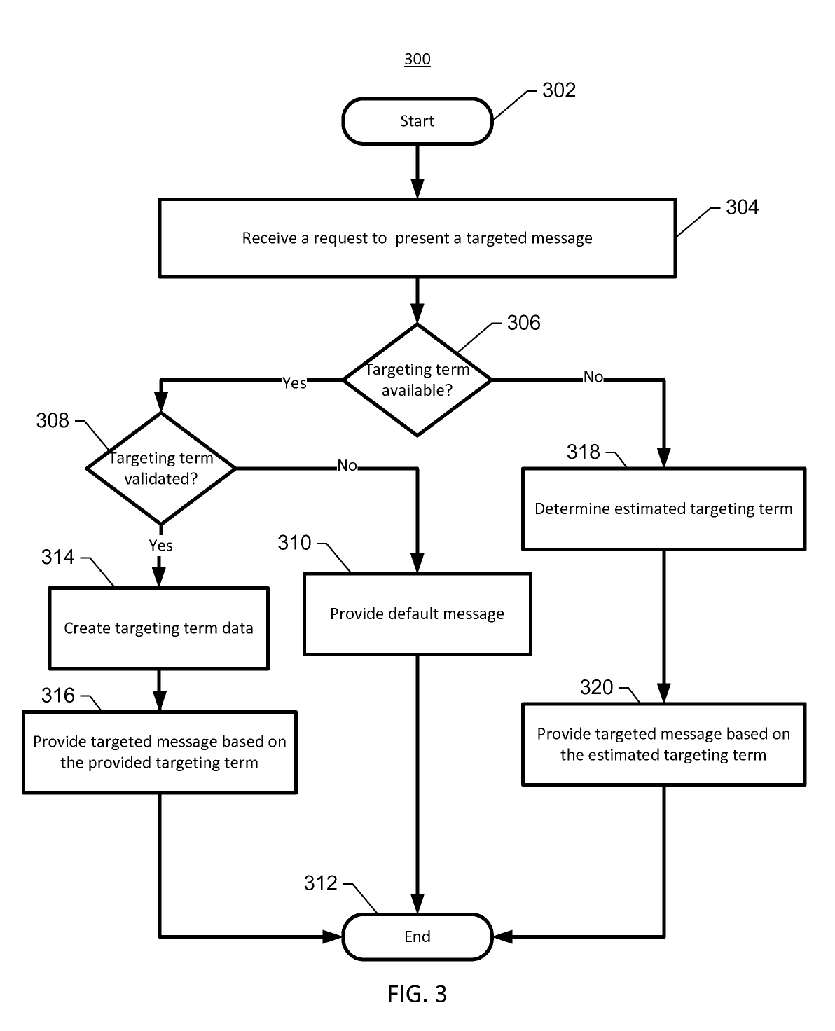

FIG. 3 shows an example of a method 300 for providing a targeted message, performed in accordance with some embodiments. For clarity, method 300 is described herein as being performed by system 100 (e.g., server 114 of system 102) shown in FIG. 1. However, other suitable devices and/or systems may be used in various other embodiments.

Method 300 may begin at 302, and proceed to 304, where server 114 may be configured to receive a request to present a targeted message on any suitable message canvas. The message canvas may include webpages, email inboxes, digital magazines, social network portals (such as newsfeeds), and/or any other backdrop that may enable the display of content and/or otherwise include one or more targeted messages.

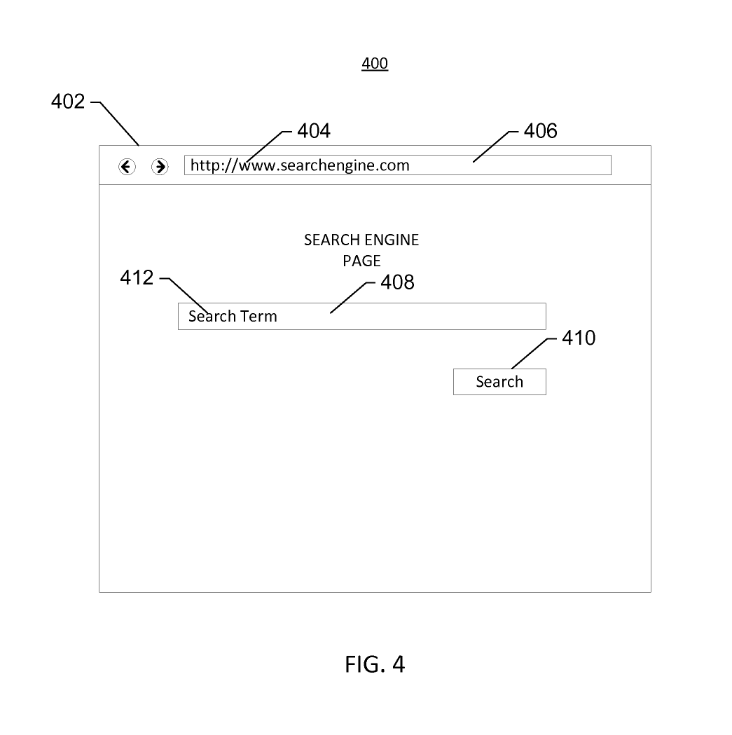

For example, the request may be received from publisher server 110 and/or user device 106. The request may be received upon a user device accessed a publisher webpage via a search engine reference provided by a search engine server. For example, user device 106 may be configured to communicate with potential targeting term provider 108 via network 104 while browsing the Internet. FIG. 4 shows an example search engine main display 400 that may be provided for display on user device 106 (e.g., on a display device) from potential targeting term provider 108 (e.g., when potential targeting term provider 108 is a search engine), in accordance with some embodiments. User device 106 may be configured to access search engine main display 400, such as via a browser 402 and/or other application, upon entering search engine URL address 404 within address bar 406 of browser 402.

Search engine main display 400 may further include search term entry field 408 and search selection 410. Upon the user entering a search term, such as search term 412, into search term entry field 408 and selecting search selection 410, user device 106 may be configured to send search term 412 to potential targeting term provider 108 with a request for search engine results.

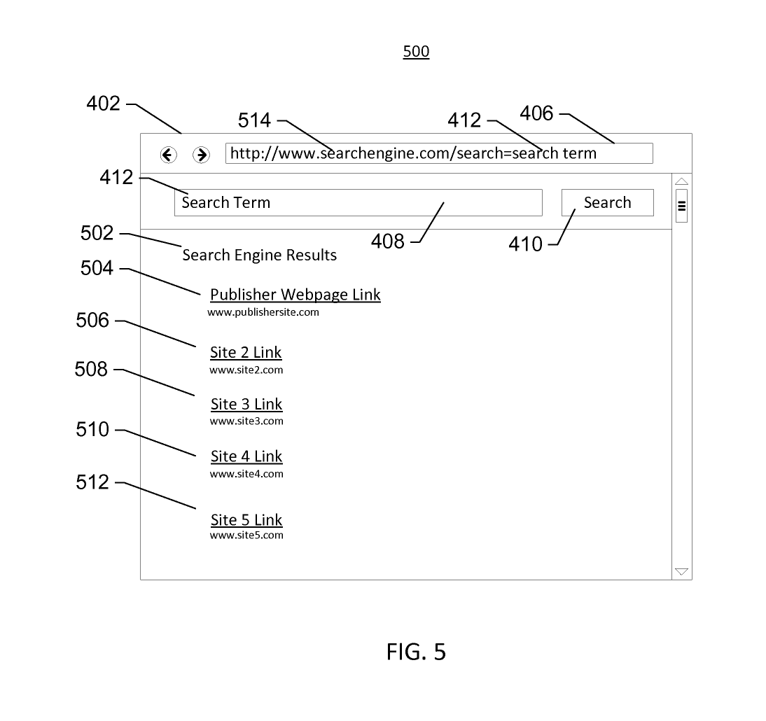

FIG. 5 shows an example search engine results display 500, in accordance with some embodiments. Search engine results display 500 may be provided for display on user device 106 from potential targeting term provider 108, such as in response to potential targeting term provider 108 receiving search term 412 from user device 106. As shown, search engine results display 500 may include result list 502, including publisher reference 504, and other references 506, 508 and 510, generated based on search term 412.

Publisher reference 504 may include a reference (e.g., a URL) for accessing content provided by publisher server 110. Upon the user selecting publisher reference 504, user device 106 may be configured to request and receive content from publisher server 110. For example, when publisher reference 504 is pointed to a webpage, publisher server 110 may be configured to provide a publisher webpage display to user device 106. As such, upon user device 106 accessing the webpage via a search engine, server 114 may be configured to determine that the user device has accessed the webpage via publisher reference 504 provided by potential targeting term provider 108, such as via a notification from user device 106 and/or publisher server 110.

Search engine results display 500 may further include results page URL 514, which may be shown within address bar 406 of browser 402. In some embodiments, results page URL 514 may include search term 412, as shown by the “search term” within “http://www.searchengine.com/search=search term” of results page URL 514.

Returning to FIG. 3, at 306, server 114 may be configured to determine whether a targeting term is included in the request and is available. For example, the targeting term may be provided by the potential targeting term provider. When the potential targeting term provider is a search engine, it may be configured to provide or otherwise make available search term 412. In some embodiments, search term 412 may be extracted from an HTTP referrer header provided by potential targeting term provider 108. For example, when the user selects publisher reference 504, potential targeting term provider 108 may be configured generate a request to publisher server 110 for user device 106. The request may include the HTTP referrer header indicating the last page the user was on, and in some embodiments, may include results page URL 514 including search term 412. In various embodiments, the search term may be determined to be provided by the search engine when the search term is available from the HTTP referrer header, or by any other technique in which an actual search term may be determined.

Some potential targeting term providers 108 may be configured to omit, obfuscate, hide, or otherwise conceal the targeting term from publisher server 110 and/or server 114. For example, the HTTP referrer header, results page URL within the HTTP referrer header, and/or the search term itself may be encrypted, blank, or otherwise fail to be communicated to server 114. In another example, a user may have reached the webpage by other means other than a search engine search. If the targeting term is unavailable (e.g., for any reasons), the targeting team may be determined to be not provided at 306.

If the targeting term is determined to be available at 306, method 300 may proceed to 308. At 308, server 114 may be configured to determine whether the targeting term is validated. This validation step, when performed, may ensure that targeting terms directed to simply locating the publisher's website are precluded from being used as targeting term data because such searches may are typically less valuable to advertisers. In some embodiments, server 114 may be configured to compare search term 412 with the publisher's webpage URL, trademark(s), business name, product/service name or trademark, and/or the like. For example, a targeting term that is identical or otherwise too closely matching the webpage URL (e.g., with or without “www,” “.com,” “.net,” “.org,” etc.) may be discarded.

If the targeting term is determined to be not validated at 308, method 300 may then proceed to 310, where server 114 may be configured to provide a default message. For example, the default message may be an advertisement that is not determined based on a targeted term. The content of the default message may be determined based on the content of the publisher webpage, user information, targeted message bids, etc. Alternatively, the user may be not presented with any message. Method 300 may then end at 312.

Returning to 308, if the targeting term is determined to be available and valid, method 300 may proceed to 314. At 314, server 114 may be configured to create targeted term data based on the provided targeting term. The targeted term data, for example, may include historical information associated with the targeting term. For example, search term 412 (e.g., as shown in FIGS. 4 and 5) may be extracted (e.g., from HTTP referrer header) and stored in association with the URL of the publisher webpage to indicate that the user reached the webpage using search term 412 with the search engine. In other embodiments, the targeting term may be associated with a message canvas other than a publisher webpage, such as an email message, text message, etc. In some embodiments, method 300 may omit 314. Similarly, various steps of the methods discussed herein may be omitted, combined, and/or otherwise modified without departing from the spirit of the invention.

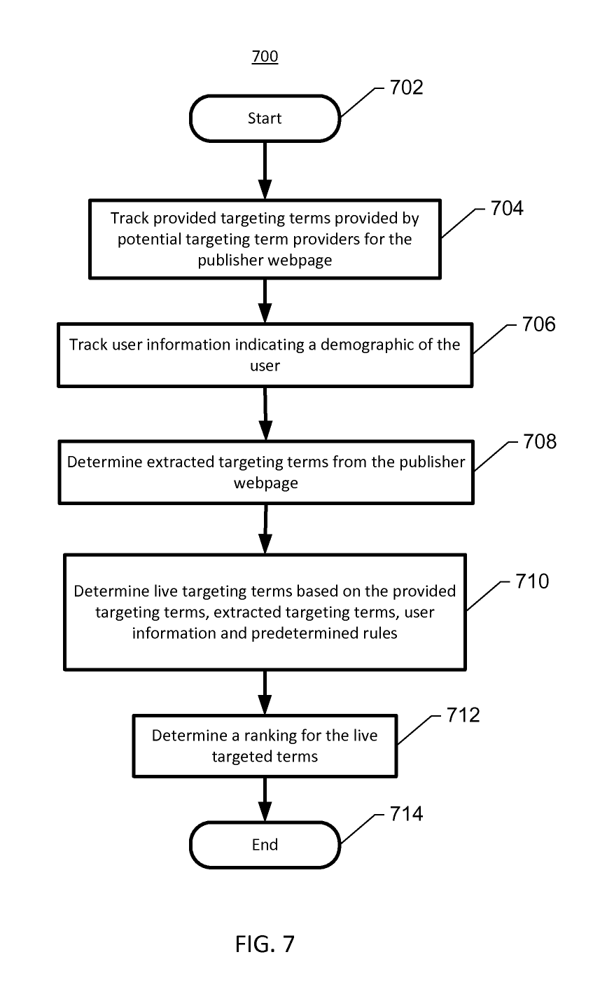

As discussed in greater detail below in connection with FIG. 7 and method 700, creating the targeting term data may in some embodiments include collecting historical data including targeting terms and associated data, applying data processing to the historical data, and creating live targeting term data based on the historical data for reference in providing the targeted messages. Furthermore, in some embodiments, targeting terms may be collected in a database (e.g., historical targeting term database 116) and selectively transferred to a second database (e.g., (live targeting term database 118) as collected targeting terms are determined to meet filtering requirements for live deployment. Additionally and/or alternatively, the live and/or historical targeting term data may be scored, ranked (e.g., top search terms per URL, top search terms per URL per advertising territory, etc.) or otherwise processed to facilitate determination of the estimated targeting term (e.g., at 318).

In some embodiments, creating the targeting term data may alternatively or additionally include creating historical information in the form of user data to be stored on user device 106. For example, server 114 may be configured to provide the historical information via a browser cookie or the like to user device 106. The browser cookie may include similar information as that stored in databases 116 and/or 118, such as the provided, targeting term, the webpage URL, user information, etc. As discussed in further detail at 318, in some embodiments, server 114 may be configured to access one or more browser cookies on user device 106 to access the historical information and targeting term data.

At 316, server 114 may be configured to provide a targeted message based on the provided targeting term. For example, the provided targeting term may be used as a targeting term for determining a targeted message, such as an advertisement, promotion, etc. that is most relevant, suitable, valuable, or the like, to the user. In some embodiments, server 114 may be further configured to compare the provided targeting term with targeting data term (e.g., search terms and/or keywords) associated with targeted messages. In response to determining that the targeting term matches one of the search terms and/or keywords, server 114 may be further configured to provide the targeted message associated with the one of the search terms and/or keywords. Method 300 may then proceed to 312 and end.

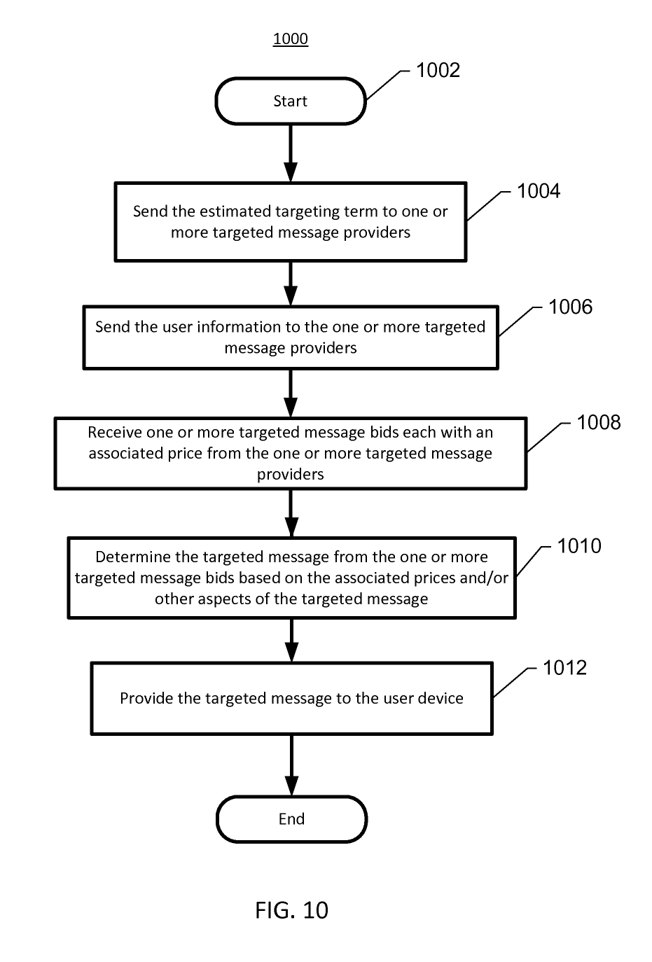

Returning to 306, if the targeting term is not available (e.g., not provided by the potential targeting term provider), method 300 may proceed to 318. At 318, server 114 may be configured to determine an estimated targeting term. An “estimated targeting term,” as used herein, refers to a targeting term that is determined based on relevant contextual information rather than from being received from the potential targeting term provider. As discussed below in greater detail in connection with FIG. 10 and method 1000, in some embodiments, determining the estimated targeting term may be based on referencing targeting term data (e.g., as created at 314). The targeting term data, for example, may include historical information associated with available targeting terms (e.g., previously provided by potential targeting term providers. For example, server 114 may be configured to access the live targeting term data stored in live targeting term database 118. Additionally and/or alternatively, server 114 may be configured to query historical targeting term database 118 to generate the live targeted term data.

In some embodiments, server 114 may be additionally and/or alternatively configured to access one or more browser cookies on user device 106 to access the historical information and targeting term data for determining the estimated targeting term. For example, upon the user returning to the publisher webpage or another publisher webpage, the browser cookie may be retrieved. Here, the estimated search term may be based on search terms historically used by the particular user. Furthermore, the historical information may be stored at user device 106 (e.g., rather than or in addition to being stored within targeted messaging system 102.

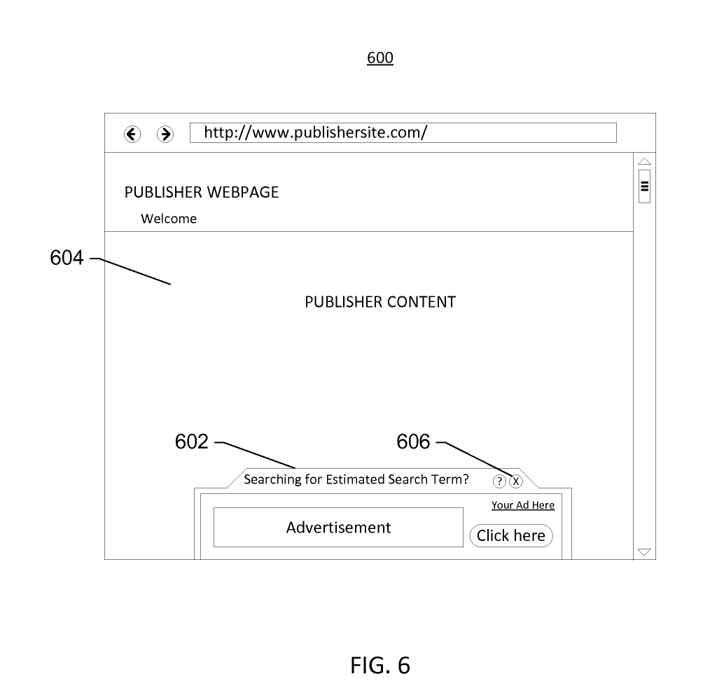

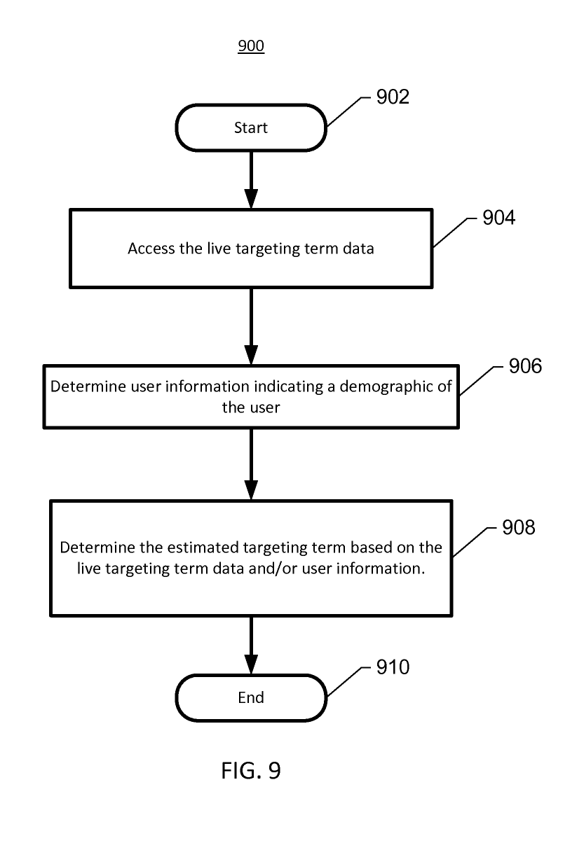

At 320, server 114 may be configured to provide the targeted message based on the estimated targeted term. The targeted message may be any message that is determined based on the estimated targeting term (e.g., determined based on historical information) and may be in any suitable format and medium. As discussed above, in some embodiments, the targeted message may be an advertisement displayed with the webpage provided by publisher server 110. FIG. 6 shows an example advertisement display 600, in accordance with some embodiments. Advertisement display 600 may be provided for display on user device 106 with a publisher's webpage, such as in response to the user selecting publisher reference 504 in results list 502 of search engine results display 500, as shown in FIG. 5. Advertisement display 600 may include advertisement 602 and publisher's webpage 604. Advertisement 602 may include one or more messages, images, videos, selectable links, audio, and/or the like. In some embodiments, the content of advertisement 602 may be received from targeted message provider 112, such as in response to a request for the advertisement sent from server 114, where the request includes the estimated targeting term. Additional details regarding providing the targeted message based on the estimated targeting term and/or the provided targeting term (e.g., at 316), applicable to some embodiments, are discussed below in connection with FIG. 9 and method 900. Method 300 may then proceed to 312 and end.

FIG. 7 shows an example of a method 700 for generating live targeting term data, performed in accordance with some embodiments. The live targeting term data may include historical information associated with available targeting terms that can be used to provide targeted messages. For clarity, method 700 is described herein as being performed by system 100 (e.g., server 114 of system 102) shown in FIG. 1. However, other suitable devices and/or systems may be used in various other embodiments. In some embodiments, method 700 may be performed at 314 of method 300, such as after the targeting term is determined to be available from the potential targeting term provider at 306. receive a request to present a targeted message;

Method 700 may begin at 702 and proceed to 704, where server 114 may be configured to track provided targeting terms provided by potential targeting term providers for the publisher webpage. Server 114 may be configured to associate each targeting term (e.g., after validated at 308 or otherwise) with the publisher's webpage. For example, the provided targeting terms may be stored in historical targeting term database 116 in association with the URL of the publisher's webpage as historical targeting term data. In some embodiments, server 114 may be configured to store the provided targeting terms and associated data in a log file, which may be then sent to historical targeting term database 116. In some embodiments, a plurality of servers 114 may each generate separate log files which may be collected and stored in historical targeting term database 116 (e.g., at scheduled times, upon receipt of new targeting term data, etc.).

At 706, server 114 may be configured to track user information indicating a demographic of the user. For example, server 114 may determine an advertising territory for the user based on the user's location. The user's location can be determined using any suitable technique such as by Internet Protocol (IP) address, IP group, browser and/or cookie data, user account data, use profile data, or the like. In some embodiments, user device 106 may include location determination circuitry, such as circuitry suitable for cell tower triangulation, global positioning systems (GPS), etc. In some embodiments, historical targeting terms may be further categorized based on the user information, such as by the user's advertising territory, device platform, search engine used, age, location, interests, gender, and/or any other type of demographic information. In another example, the user information may include a dwell time indicating how long the user stayed at the webpage for a targeting term. If the user stays on the webpage for a longer period of time, the targeting term may be more relevant than if the left the publisher webpage fairly quickly. In some embodiments, the user information may also be placed in the log file generated by server 114.

At 708, server 114 may be configured to determine extracted targeting terms from the publisher's webpage. For example, server 114 may be configured to access the publisher's webpage via publisher server 110 and process webpage content such as body data (e.g., text, images, videos, etc.) and metadata (e.g., title, description, URL, etc.). Based the webpage content, server 114 may be configured to extract one or more extracted targeting terms. Such extracted targeting terms, when used, may provide additional targeting term candidates for the estimated targeting term that have a contextual relevance to the publisher webpage. For example, an extracted targeting term such as “computer monitor” may be a relevant targeting term for a publisher's webpage about computers. Furthermore, the extracted targeting term may indicate the contextual relevance of the publisher's webpage as an advertising platform for computer monitor merchants. As such, the extracted targeting term may also be stored in historical targeting term database 116 in association with the webpage URL as historical targeting term data. Additionally and/or alternatively, the extracted targeting term may be used to provide the default targeted message as a targeting term based message, such as when no estimated targeted term and/or provided targeted term can be determined. In some embodiments, extracting targeted terms may be performed by one or more separate servers other than the runtime servers providing the targeted messages for publisher webpages (e.g., server 114).

At 710, server 114 may be configured to determine one or more live targeting terms. The live targeting terms may be generated based on the provided targeting terms, extracted targeting terms, historical targeting terms, and/or user information, such the data stored in historical targeting term database 116. In some embodiments, for each publisher webpage URL, server 114 may be configured to determine a count for how many times each targeting term caused potential targeting term providers to direct users to the publisher's webpage. Furthermore, data associated with the webpage visit, such as user information, location, dwell time, demographics, etc. can also be tracked. Based on this data, server 114 may be further configured to categorize and/or rank search terms by any combination of criteria, such as advertising territory (e.g., by country, language, product availability, etc. to track how many times each search term caused search engines to direct users to the publisher's webpage individually for each advertising territory) of the user and/or other user demographic information. Here, the one or more live targeting terms may include the top ranked targeting terms for a given set of one or more criteria. In some embodiments, different categories and rankings may be generated via queries to historical targeting term database 116.

Additionally and/or alternatively, one or more predetermined rules may be applied to the targeting terms in historical targeting term database 116 to determine a ranking and/or whether they should be placed in live targeting term database 118. In some embodiments, the predetermined rules may ensure that only useful, reliable, valuable, or otherwise suitable targeting terms are used as live targeting terms.

In some embodiments, upon a targeting term in historical targeting term database 116 satisfying the predetermined rules, the targeting term may be added to the live targeting term data. For example, a targeting term may be added to the live targeting term data and/or placed in live targeting term database 118 if the targeting term meets one or more of the following criteria: (1) the targeting term is less than or equal to N (e.g., 8) words, (2) the targeting term has received at least M (e.g., 3) successful targeted message displays (e.g., the targeting term has received at least M bids above a minimum price threshold from one or more targeted message providers 112), and/or (3) if no targeting term for a particular webpage has received at least M successful targeting message displays, the targeting term will qualify if all the words of the targeting term appear in the website URL and/or if the targeting term can be otherwise extracted from the publisher webpage. N and M, as used herein, may refer to any positive integer.

In some embodiments, when no targeting term meets the predetermined criteria or is otherwise available, server 114 may be configured to determine extracted targeting term data. For example, server 114 may determine whether the webpage URL includes more than 2 delimited words, and if so, select the longest sequence of the delimited words that also appear in other metadata (e.g., keywords, title, description) of the webpage as a live targeting term.

At 712, server 114 may be configured to determine a ranking for the live targeted terms. For example, if there are more than a predetermined number (e.g., 5) of live targeting terms associated with webpage URL (e.g., meeting a particular criteria), server 114 may be configured to rank the live targeting terms. Alternatively and/or additionally, the ranking may be performed based on the collected and/or historical targeting terms, such as to generate the live targeting term data.

In some embodiments, server 114 may be configured to store the targeting term data collected at runtime in a log file or the like. The log file may include, for example, the URL of the webpage, the provided search term, and the advertising territory (e.g., country code) of the user, and/or other associated data. The log file may then be sent from search server 114 (or a plurality of servers 114) to historical targeting term database 116. As discussed above, historical targeting term database 116 may include a Hadoop file system. At various times, which may be predetermined, scheduled (e.g., daily, weekly, hourly, etc.), upon request, etc., the targeting term data may be aggregated and processed to create the live targeting term data and/or the ranking. In some embodiments, different ranking categories and criteria may be determined on demand, such as via ranking request (e.g., query) to the Hadoop file system. Furthermore, live targeting term data may be removed or otherwise ignored based on its freshness (e.g., creation date) to remove out of date information.

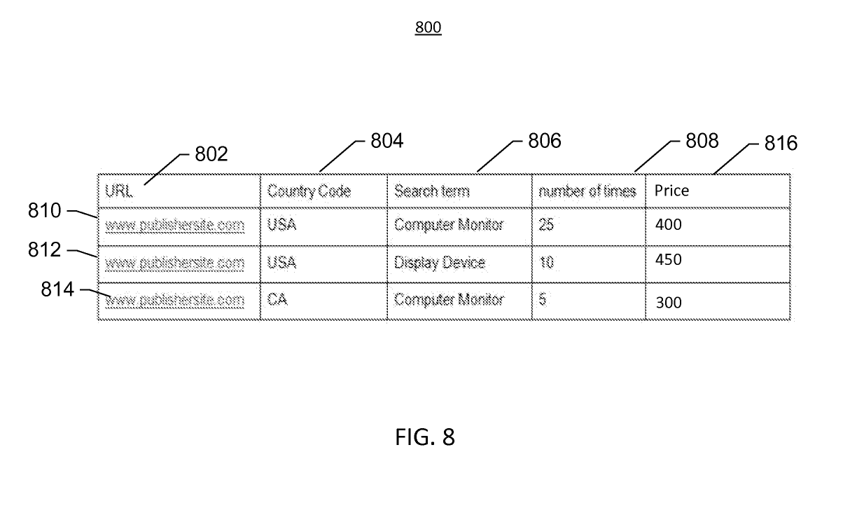

FIG. 8 shows an example table 800 including example live targeting term data. Table 800 may be generated by server 114 or one or more separate servers (e.g., a Hadoop server farm) based on the historical data, such as collected targeting term data. For example, the table may indicate targeting terms that meet various criteria and their ranking based on the criteria. Table 800 is shown as being constructed based on the URL/country code/search term/number of times users have accessed the webpage using various targeting terms. Table 800 may include a unique entry for each targeting term associated with a website URL and country code as shown by search term field 806, webpage URL field 802, and country code field 804, respectively. Furthermore, it may be determined (e.g., based on the historical targeting term data) how many times users from the advertising territory (e.g., United States, as determined by country code field 804) have accessed the webpage using the targeting term as shown by search term count 808. For example, table 800 shows that the webpage has been accessed via the search term “Computer Monitor” 25 times from users in the United States. Furthermore, the search term “Computer Monitor” has a higher search term count than the search term “Display Device,” having only a search term count of 10. However, the same search term “Computer Monitor” is also shown for Canada, being in a separate category, as having a search term count of 5.

In some embodiments, table 800 may further include price entry 816 for each targeting term. Price entry 816 may indicate a price that that a targeted message provider may be willing to pay (e.g., historically and/or based on predetermined agreements) for showing a targeted message on the publisher site based on the targeting term. In some embodiments, price entry 816 may include an estimated price. The estimated price, for example, may be based on one or more historical prices for the targeting term.

While table 800 shows search terms arranged by country code, one or more other categories may be used alternatively or in addition to further define categories for keeping count and/or ranking of the search terms. For example, the search term “Computer Monitor” could have an entry in table 800 or the like with a different search term count for each unique combination of webpage URL, country code, various user demographics (e.g., was search term collected from a male or female, age of user, or the like), price, search engine used, etc. Some other example categories for organizing search terms may include user information (e.g., based on the user's profile, IP address, IP group, user profile, and user location), browser user agent, platform, search engine used, etc. Furthermore, while table 800 shows categorized search terms ranked by targeting term count (e.g., search term count), other criteria that may additionally and/or alternatively be used for the ranking may include historical search term prices for advertisers, click rate of advertisements provided based on each search term, the freshness of the search term data, or combinations thereof (e.g., with different criteria having a different (e.g., weighted) priority that contributes to an overall ranking). Returning to FIG. 7, method 700 may then end at 714.

FIG. 9 shows an example of a method 900 for determining an estimated targeting term, performed in accordance with some embodiments. For clarity, method 900 is described herein as being performed by system 100 (e.g., server 114 of system 102) shown in FIG. 1. However, other suitable devices and/or systems may be used in various other embodiments. For example, method 900 can be performed by a different server (e.g., either in via virtualization and/or via separate hardware) than a server performing method 800 and/or other targeting term data collection and processing tasks. In some embodiments, method 900 may be performed at 318 of method 300, such as after the targeting term is determined to be not provided by the search engine at 306).

Method 900 may begin at 902 and proceed to 904, where server 114 may be configured to access the live targeting term data. The targeting term data, as discussed above, may be generated based on historical targeting term data stored in historical targeting term database 116 and/or may be accessed from live targeting term database 118. In some embodiments, the live targeting term data may indicate a ranking of targeting terms, such as the one shown in table 800 of FIG. 8. Furthermore, the live targeting terms may include one or more extracted targeting terms, which may also be ranked with and/or separately from the historical targeting terms collected from users. In some embodiments, extracted targeting terms may be used as live search terms only when there are no usable collected targeting terms.

At 906, server 114 may be configured to determine user information indicating a demographic of the user. For example, as discussed above, some example categories by which targeting terms may be ranked include the user's demographic data (e.g., age, gender, interests, location, etc.). Accordingly, those and/or similar data may be collected from the user (e.g., using similar or different techniques as applied in the first data collection where a targeting term was provided) to match the user with selected criteria (e.g., as applied to determine the counting and/or rankings of the live targeting term data).

At 908, server 114 may be configured to determine the estimated targeting term based on the live targeting term data and/or user information. For example, after the user is determined to have visited publisher webpage URL 802, user information indicating that the user is within the United States may be used to determine that targeting term entry 810 (e.g., the row at 810) and targeting term entry 812 are potential candidates for the estimated targeting term. Targeting term entry 814 is associated with the Canada (“CA”) country code and is therefore not considered. Server 114 may be configured to select the most highly ranked targeting term (e.g., as shown by search count 808) meeting the applicable criteria. In some embodiments, server 114 may be configured to generate a new request to historical targeting term database 116 that creates new live targeting term data (e.g., a different table) with a different ranking based on the stipulations of a new query (e.g., as determined based on the user information). Method 900 may then end at 910.

FIG. 10 shows an example of a method 1000 for generating a targeted message based on the estimated targeting term, performed in accordance with some embodiments. For clarity, method 1000 is described herein as being performed by system 100 (e.g., server 114 of system 102) shown in FIG. 1. However, other suitable devices and/or systems may be used in various other embodiments. For example, method 1000 can be performed by a different server (e.g., either in via virtualization and/or via separate hardware) than a server performing method 800 and/or method 900. In some embodiments, method 1000 may be performed at 316 (e.g., based on a provided search tern) and 320 (e.g., based on an estimated targeting term) of method 300. Furthermore, while method 1000 is described as being applicable to estimated targeting terms, it may also be applicable to extracted, and/or provided targeting terms.

Method 1000 may begin at 1002 and proceed to 1004, where server 114 may be configured to send the estimated targeting term (e.g., as determined at 908 of method 900) to one or more targeted message providers. For example, targeted message provider server 112 (e.g., as shown in FIG. 1) may be one or more servers associated with a single merchant, or multiple merchants. In some embodiments, server 114 may be further configured to compare the estimated targeting term with targeting term data (e.g., search terms and/or keywords) associated with targeted messages. In response to determining that the estimated targeting term matches one of the search terms and/or keywords, server 114 may be further configured to send the estimated targeting to one or more targeted message providers.

At 1006, server 114 may be further configured to send the user information to the one or more targeted message providers. As discussed above, the user information may indicate a demographic of the user, such as the user's location, interests, age, gender, etc. In addition to the estimated targeting term, user information (when sent) may further aid targeted message provider 112 in selecting a more targeted, relevant, useful, and/or valuable advertisement for the user. Furthermore, any other additional information that may be useful to targeted message provider 112 may be sent such as the webpage URL, the search engine used, etc. In some embodiments, the user information may be used to determine the estimated targeting term and is not further provided to the one or more targeted message providers.

At 1008, server 114 may be configured to receive one or more targeted message bids each with an associated price from the one or more targeted message providers. For example, responsive to receiving the estimated targeting term and/or user information, targeted message provider 112 may be configured to determine one or more matching targeted messages and associated targeted message bids. A targeted message bid for a targeted message may indicate the associated price that the advertiser is willing to pay the system to display the targeted message on the publisher's webpage. For example, if the targeting term is “Computer Monitor,” then targeted message provider 112 may be configured to determine a targeted message bid for each of one or more targeted messages related to “Computer Monitor” and to send the targeted message bid(s) to server 114.

At 1010, server 114 may be configured to determine the targeted message from the one or more targeted message bids based on the associated prices and/or other aspects of the targeted message. For example, the targeted message having the top associated price may be selected. Additionally and/or alternatively, one or more other factors may be considered such as the click-through-rate of the targeted messages and/or other potential multi-factor (e.g., weighted) scoring mechanisms.

At 1012, server 114 may be configured to provide the targeted message to the user device. For example, the targeted message may be a display advertisement shown with the publisher webpage, such as advertisement 602 and publisher's webpage 604 in advertisement display 600 of FIG. 6. In some embodiments, server 114 may be configured to trigger advertisement 602 in a full mode. For example, advertisement 602 may be a sliding or fixed overlay with respect to webpage 604. Furthermore, while advertisement 602 is in full mode, it may be floating above the content of webpage 604, such as by persisting even when the user scrolls through webpage 604.

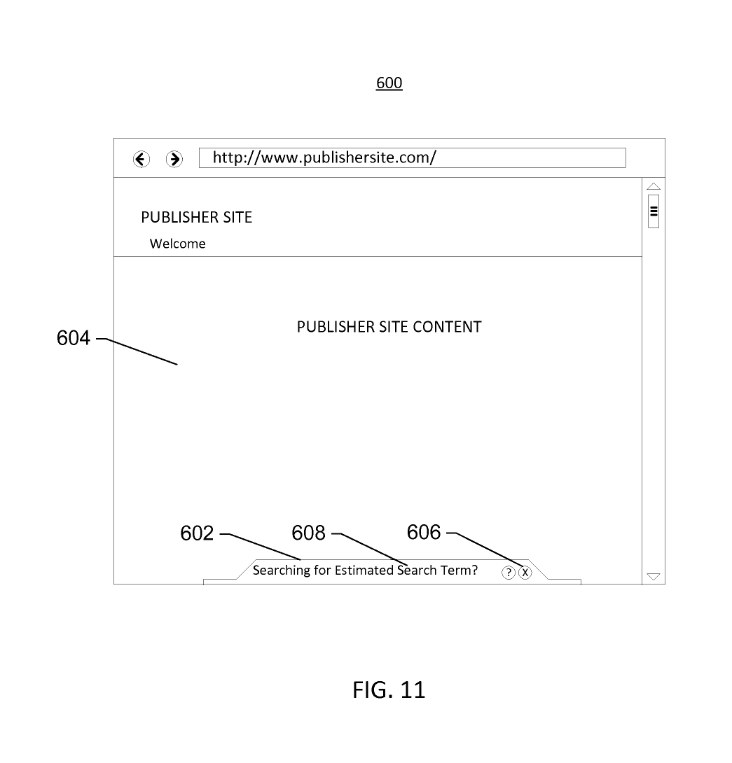

In some embodiments, upon the user selecting minimize selection 604 and/or following a predetermined period of time (e.g., 5-15 configurable seconds), advertisement 602 may be minimized or otherwise hidden. FIG. 11 shows an example advertisement display 600 after advertisement 602 has been minimized to the bottom of advertisement display 600. In some embodiments, advertisement 602 may be returned to full mode upon the user selecting or hovering over advertisement ribbon 608.

Returning to FIG. 6, advertisement 602 may further include text, images, video or other advertisement data at 610. Furthermore, advertisement 602 may include one or references to the advertiser's webpage, service, contact information, or the like, such as advertiser reference 612. Finally, advertisement 602 may include a your add here selection 614 that may allow the user to place advertisements on publisher webpage 604 (or other associated publishers) via the search system. Method 1000 may then end at 1014.

### CONCLUSION

Many modifications and other embodiments will come to mind to one skilled in the art to which these embodiments pertain having the benefit of the teachings presented in the foregoing descriptions and the associated drawings. For example, the techniques discussed herein involving messages other than or in addition to webpage advertisements may easily be implemented by a person of ordinary skill in the art in view of the discussion herein. For example, messages presented on any other type of digital canvas, such as an electronic magazine, social network wall, highway billboard, automobile display, mass transit display, email inbox, and/or electronic book. Therefore, it is to be understood that embodiments and implementations are not to be limited to the specific example embodiments disclosed and that modifications and other embodiments are intended to be included within the scope of the appended claims. Although specific terms are employed herein, they are used in a generic and descriptive sense only and not for purposes of limitation.

That which is claimed:

1. A system comprising:
circuitry configured to:
receive a request to present a targeted message;
in response to receiving the request, determine whether one or more targeting terms are included in the request and are available;
in response to determining that the targeting terms are unavailable, access historical information associated with available targeting terms; and
provide a targeted message based on the historical information.

2. The system of claim 1, wherein the targeting terms are search terms and the search terms are unavailable because the search terms were omitted by a search engine.

3. The system of claim 1, wherein the circuitry is further configured to:
receive a second request to present a second targeted message;
in response to receiving the second request, determine whether at least one second targeting term is included in the second request and is available; and
in response to determining the second targeting term is included in the second targeted message and available:
extract the second targeting term;
compare the second targeting term with keywords associated with targeted messages;
in response to determining the second targeting term matches one of the keywords, provide a keyword-based targeted message associated with the one of the keywords; and
store the second targeting term in a database such that the second targeting term is associated with the historical information.

4. The system of claim 3, wherein the circuitry is further configured to, in response to determining the second targeting term is included in the second targeted message and available:
receive user information associated with a user indicating an advertising territory of the user; and
store the user information in the database such that the user information is associated with the historical information.

5. The system of claim 1, wherein the circuitry is further configured to access the historical information by:
generating a ranking request to a database, the ranking request indicating one or more ranking criteria for targeting terms; and
receiving the historical information from the database, the historical information indicating a ranking of one or more targeting terms based on the one or more ranking criteria.

6. The system of claim 5, wherein the ranking is based on country code and targeting term count.

7. The system of claim 5, wherein:
the ranking is based on one or more of publisher webpage referral count, dwell time, price for historic targeted advertisement bids, targeted advertisement click rate, time of collection for the targeting terms, and search engine source; and
the circuitry is further configured to:
determine an estimated targeting term based on the ranking; and
provide the targeted message based on the estimated targeting term.

8. The system of claim 1, wherein the circuitry is further configured to:
determine an extracted targeting term from a publisher webpage; and
associate the extracted targeting term the historical information.

9. The system of claim 1, wherein the processing circuitry is further configured to:
receive user information associated with a user indicating an advertising territory of the user;
determine an estimated targeting term based on the user information; and
provide the targeted message based on the user information.

10. The system of claim 1, wherein the processing circuitry is further configured to:
determine an estimated targeting term based on the historical information;
send the estimated targeting term to one or more targeted message provider servers;
receive one or more targeted message bids each including an associated price from the one or more targeted message provider servers; and
determine the targeted message from the one or more targeted message bids based on the associated prices.

11. The system of claim 10, wherein the processing circuitry is further configured to:
receive user information associated with the user indicating a demographic of the user; and
send the user information to the one or more targeted message provider servers for determination of the one or more advertisement bids.

12. The system of claim 1, wherein the circuitry is further configured to:
receive the historical information as browser cookie data from a user device associated with a user; and
provide the targeted message to the user device.

13. A method for providing an advertisement, comprising:
receiving a request to present a targeted message;
in response to receiving the request, determining whether one or more targeting terms are included in the request and are available;
in response to determining that the targeting terms are unavailable, accessing historical information associated with available targeting terms; and
providing a targeted message based on the historical information.

14. The method of claim 13, wherein the targeting terms are search terms and the search terms are unavailable because the search terms were omitted by a search engine.

15. The method of claim 13 further comprising:
receiving a second request to present a second targeted message;
in response to receiving the second request, determining whether at least one second targeting term is included in the second request and is available;
in response to determining the second targeting term is included in the second targeted message and available:
extracting the second targeting term;
comparing the second targeting term with keywords associated with targeted messages;
in response to determining the second targeting term matches one of the keywords, providing a keyword-based targeted message associated with the one of the keywords; and
storing the second targeting term in a database such that the second targeting term is associated with the historical information.

16. The method of claim 15 further comprising, in response to determining the second targeting term is included in the second targeted message and available:
receiving user information associated with a user indicating an advertising territory of the user; and
storing the user information in the database such that the user information is associated with the historical information.

17. The method of claim 13, wherein accessing the historical information includes:
generating a ranking request to a database, the ranking request indicating one or more ranking criteria for targeting terms; and
receiving the historical information from the database, the historical information indicating a ranking of one or more targeted terms based on the one or more ranking criteria.

18. The method of claim 17, wherein the ranking is based on country code and targeting term count.

19. The method of claim 17, wherein:
the ranking is based on one or more of publisher webpage referral count, dwell time, price for historic advertisement bids, advertisement click rate, time of collection for the targeting terms, and search engine source; and
the method further includes:
determining an estimated targeting term based on the ranking; and
providing the targeted message based on the estimated targeting term.

20. The method of claim 13 further comprising:
determining an extracted targeting term from a publisher webpage; and
associating the extracted targeting term the historical information.

21. The method of claim 13 further comprising:
receiving user information associated with a user indicating an advertising territory of the user;
determining an estimated targeting term based on the user information; and
providing the targeted message based on the user information.

22. The method of claim 13 further comprising:
determining an estimated targeting term based on the historical information;
sending the estimated targeting term to one or more targeted message provider servers;
receiving one or more targeted message bids each including an associated price from the one or more targeted message provider servers; and
determining the targeted message from the one or more targeted message bids based on the associated prices.

23. The method of claim 22 further comprising:
receiving user information associated with the user indicating a demographic of the user; and
sending the user information to the one or more targeted message provider servers for determination of the one or more advertisement bids.

24. The method of claim 13 further comprising:
receiving the historical information as browser cookie data from a user device associated with a user; and
providing the targeted message to the user device.

25. A computer program product comprising a non-transitory computer readable storage medium and computer program instructions stored therein, the computer program instructions comprising program instructions for:
receiving a request to present a targeted message;
in response to receiving the request, determining whether one or more targeting terms are included in the request and are available;
in response to determining that the targeting terms are unavailable, accessing historical information associated with available targeting terms; and
providing a targeted message based on the historical information.
